(19) United States
(12) Patent Application Publication
(10) Pub. No.: US 2026/0332726 A1
(43) Pub. Date: Oct. 22, 2026

(54) DYNAMIC PROCESSING METHOD AND DEVICE BASED ON DRONE VIDEO PYRAMID MODEL

(71) Applicant: AEROSPACE INFORMATION RESEARCH INSTITUTE, CHINESE ACADEMY OF SCIENCES, Beijing (CN)

(72) Inventors: Hongdeng JIAN, Beijing (CN); Xiangtao FAN, Beijing (CN); Xiaoping DU, Beijing (CN)

(73) Assignee: AEROSPACE INFORMATION RESEARCH INSTITUTE, CHINESE ACADEMY OF SCIENCES, Beijing (CN)

(21) Appl. No.: 19/099,543

(22) PCT Filed: Dec. 2, 2022
(86) PCT No.: PCT/CN2022/136213

§ 371 Date: Jan. 29, 2025

(30) Foreign Application Priority Data
Aug. 17, 2022 (CN) 202210984288.5

(51) Int. Cl. H04N 7/01; G06T 3/40; G06T 7/11

(52) U.S. Cl. CPC H04N 7/0102; G06T 3/40; G06T 7/11; G06T 2207/10016; G06T 2207/10032; G06T 2207/20016

(57) ABSTRACT

A dynamic processing method and device based on a drone video pyramid model are provided, which relate to the field of real-time transmission and processing of video data. The method includes: constructing a drone video pyramid model; resampling and segmenting, by a video server, a drone video based on a video loading request using the drone video pyramid model, and dynamically scheduling and rendering, loading and displaying the resampled and segmented drone video by the client.

### TECHNICAL FIELD

The present disclosure relates to the field of real-time transmission and processing of video data, and in particular to a dynamic processing method and a dynamic processing device based on a drone video pyramid model, an electronic device, and a storage medium.

### BACKGROUND

When watching a drone video in real time through a drone image transmission system or other software, due to the large amount of drone video data and the limited performance of computer hardware and software, problems such as low drone video rendering efficiency and unsmooth system operation may occur. In the process of integrating a drone video with a two-dimensional or three-dimensional geographic information system (GIS), there are a great number of GIS scene elements. In particular, a three-dimensional GIS scene contains complex elements such as high-precision terrain, images, real-scene three-dimensional models, stereo annotations, etc. The smooth operation of the system requires high scene rendering efficiency. The access and integration of drone videos and ultra-high-definition (4K or higher resolution) drone videos have brought great challenges to the efficient rendering of two-dimensional and/or three-dimensional GIS scenes.

### SUMMARY

According to a first aspect of the present disclosure, a dynamic processing method based on a drone video pyramid model is provided, including: acquiring a viewpoint distance of a scene view camera and a field of view of the scene view camera; querying, by a client, a scale level of a current map; and acquiring a resolution of the current map based on the viewpoint distance of the scene view camera and a correspondence between the scale level of the map and the resolution of the map; constructing a drone video pyramid model based on the resolution of the current map, drone flight parameters and a preset grading rule, where the drone video pyramid model includes a plurality of grades, each of which corresponds to a respective resolution; calculating a video range within the field of view of the scene view camera based on the field of view of the scene view camera and a drone video range; sending, by the client, a drone video loading request to a video server, where the drone video loading request includes attribute information of the drone video pyramid model and the video range within the field of view of the scene view camera; receiving, by the client, a drone video resampled and segmented by the video server in response to the drone video loading request; and dynamically scheduling and rendering, loading and displaying the resampled and segmented drone video by the client; and in a case that the viewpoint distance of the scene view camera changes, repeating the above steps to resample, segment, dynamically schedule and render, load and display the drone video according to a preset requirement.

According to an embodiment of the present disclosure, the preset grading rule mentioned above is determined based on formulas (1) to (3):

Hᵢ=360×Pᵢ (1),

$${W}_{i} = \frac{W}{H} \times 360 \times {P}_{i} , \qquad ( 2 )$$

$$R = \frac{tan ( α / 2 ) \times Height}{{H}_{i}} = \frac{tan ( α / 2 ) \times Height}{360 \times {P}_{i}} , \qquad ( 3 )$$

where W is an original width pixel value of the drone video, H is an original height pixel value of the drone video, Pᵢ (i=1, 2, 3 . . . ) is a grade of the drone video pyramid model, Hᵢ is a video height pixel value corresponding to the grade Pᵢ of the drone video pyramid model, Wᵢ is a video width pixel value corresponding to the grade Pᵢ of the drone video pyramid model, R is an actual resolution of a drone image, α is a vertical field of view of the drone, and Height is a current flight altitude of the drone.

According to an embodiment of the present disclosure, the attribute information of the drone video pyramid model includes a grade of the drone video pyramid model and a resolution corresponding to the grade, where the resolutions of the drone video pyramid model sequentially increase from top to bottom.

According to an embodiment of the present disclosure, the video server resampling and segmenting the drone video in response to the drone video loading request includes: determining a resolution and a grade of the drone video based on the drone video loading request; determining a quadtree decomposition range of the drone video pyramid model, where an envelope rectangle of visible range coordinates of the scene view camera is located, based on the visible range coordinates using the resolution and the grade of the drone video; and segmenting, by the video server, the drone video based on the quadtree decomposition range, and sending the segmented drone video to the client and/or a browser for rendering.

According to an embodiment of the present disclosure, dynamically scheduling and rendering the drone video according to the preset requirement includes: in a case that the field of view of the scene view camera is smaller than a current image range of the drone video, loading part of drone video data based on position information of the scene view camera.

According to an embodiment of the present disclosure, the drone video pyramid model includes a plurality of resolutions, and the plurality of resolutions include 360P, 720P, 1080P, 4K and 8K.

According to an embodiment of the present disclosure, a minimum unit of a map tile of the current map is of 256×256 pixels or 512×512 pixels.

According to a second aspect of the present disclosure, a dynamic processing device based on a drone video pyramid model is provided, including: an acquisition module configured to: acquire a viewpoint distance of a scene view camera and a field of view of the scene view camera, query a scale level of a current map through a client, and acquire a resolution of the current map based on the viewpoint distance of the scene view camera and a correspondence between the scale level of the map and the resolution of the map; a model construction module configured to construct the drone video pyramid model based on the resolution of the current map, drone flight parameters and a preset grading rule, where the drone video pyramid model includes a plurality of grades, each of which corresponds to a respective resolution; a calculation module configured to calculate a video range within the field of view of the scene view camera based on the field of view of the scene view camera and a drone video range; a request sending module configured to send a drone video loading request to a video server through the client, where the drone video loading request includes attribute information of the drone video pyramid model and the video range within the field of view of the scene view camera; a video dynamic processing module configured to: receive, through the client, the drone video resampled and segmented by the video server in response to the drone video loading request, and dynamically schedule and render, load and display the resampled and segmented drone video on the client; and a video on-demand processing module configured to: repeat the above steps in a case that the viewpoint distance of the scene view camera changes, and resample, segment, dynamically schedule and render, load and display the drone video according to a preset requirement.

According to a third aspect of the present disclosure, an electronic device is provided, including: one or more processors and a storage device configured to store one or more programs, where when the one or more programs are executed by the one or more processors, the one or more processors perform the multi-resolution drone video dynamic processing method mentioned above.

According to a fourth aspect of the present disclosure, a computer-readable storage medium having executable instructions stored thereon is provided, where when executed by a processor, the instructions cause the processor to perform the multi-resolution drone video dynamic processing method mentioned above.

The present disclosure provides a method for dynamically processing a multi-resolution drone video, which may dynamically load drone video data with a resolution similar to the resolution of the current map based on the viewpoint distance and the field of view of the current scene view camera, thereby realizing high-performance on-demand rendering of multi-resolution drone videos and ensuring efficient scene display and smooth system operation.

### BRIEF DESCRIPTION OF THE DRAWINGS

FIG. 1 is a flowchart of a dynamic processing method based on a drone video pyramid model according to an embodiment of the present disclosure;

FIG. 2 is a schematic structural diagram of a dynamic processing method based on a drone video pyramid model according to an embodiment of the present disclosure;

FIG. 3 is a schematic diagram of a general video format of a drone video pyramid model according to an embodiment of the present disclosure;

FIG. 4 is a schematic diagram showing a 16:9 drone video format of a drone video pyramid model according to an embodiment of the present disclosure;

FIG. 5 is a flowchart of resampling and segmenting a drone video according to an embodiment of the present disclosure;

FIG. 6 is a schematic diagram showing quadtree decomposition by a drone video pyramid model at a same grade according to an embodiment of the present disclosure;

FIG. 7 is a schematic diagram showing calculation of a video range based on a visible range of a scene view camera according to an embodiment of the present disclosure;

FIG. 8 is a schematic structural diagram of a dynamic processing system based on a drone video pyramid model according to an embodiment of the present disclosure; and

FIG. 9 schematically shows a block diagram of an electronic device applicable to implementing a dynamic processing method based on a drone video pyramid model according to an embodiment of the present disclosure.

### DETAILED DESCRIPTION OF EMBODIMENTS

In order to make the objectives, technical solutions and advantages of the present disclosure clearer, the present disclosure is further described in detail below in combination with specific embodiments and with reference to the accompanying drawings.

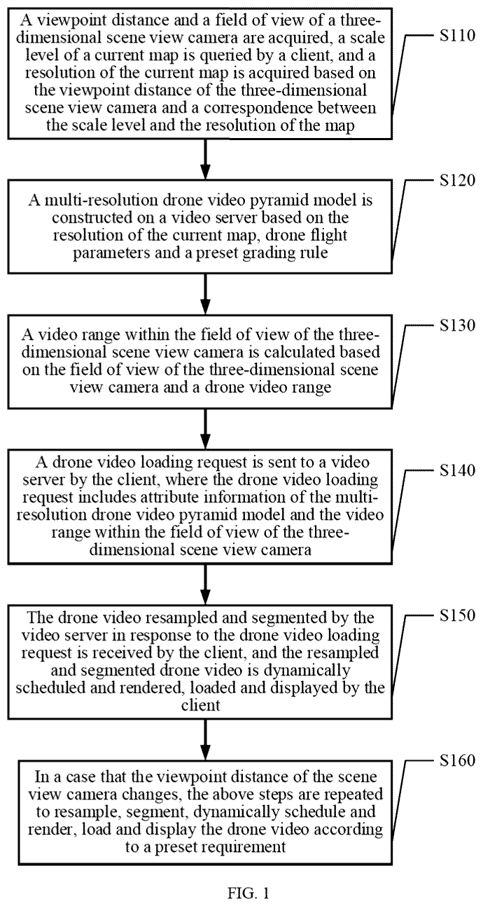

FIG. 1 is a flowchart of a dynamic processing method based on a drone video pyramid model according to an embodiment of the present disclosure.

As shown in FIG. 1, the above dynamic processing method based on the drone video pyramid model includes operations S110 to S160.

In operation S110, a viewpoint distance and a field of view of a scene view camera are acquired, a scale level of a current map is queried by a client, and a resolution of the current map is acquired based on the viewpoint distance of the scene view camera and a correspondence between the scale level and the resolution of the map.

Optionally, the scene view camera may be a two-dimensional scene camera or a three-dimensional scene camera. Therefore, the drone video dynamic processing method provided in the present disclosure may be applicable to both a dynamic processing of a drone video in a two-dimensional GIS scene and a dynamic processing of a drone video in a three-dimensional GIS scene.

In operation S120, a drone video pyramid model is constructed based on the resolution of the current map, drone flight parameters and a preset grading rule, where the drone video pyramid model includes a plurality of grades, each of which corresponds to a respective resolution.

Optionally, the above drone video pyramid model may be constructed on the client or a video server according to user requirements.

The drone video pyramid model includes a plurality of grades (i.e., hierarchical levels of the pyramid model), each of which represents a respective video resolution. Since the drone video pyramid model may represent a plurality of resolutions, the drone video dynamic processing method provided in the present disclosure is capable of processing multi-resolution drone videos.

The drone flight parameters include a drone flight altitude and a drone vertical field of view.

In operation S130, a video range within the field of view of the scene view camera is calculated based on the field of view of the scene view camera and a drone video range.

In operation S140, a drone video loading request is sent to a video server by the client, where the drone video loading request includes attribute information of the drone video pyramid model and the video range within the field of view of the scene view camera.

The attribute information of the drone video pyramid model includes a grade of the pyramid model and a resolution corresponding to the grade.

In operation S150, the drone video, which is resampled and segmented by the video server in response to the drone video loading request, is received by the client, and the resampled and segmented drone video is dynamically scheduled and rendered, loaded and displayed by the client.

In operation S160, in a case that the viewpoint distance of the scene view camera changes, the above steps are repeated to resample, segment, dynamically schedule and render, load and display the drone video according to a preset requirement.

The present disclosure provides a method for dynamically processing a multi-resolution drone video, which may dynamically load drone video data with a resolution similar to the resolution of the current map based on the viewpoint distance and the field of view of the current scene view camera, thereby realizing high-performance on-demand rendering of the multi-resolution drone video and ensuring efficient scene display and smooth system operation.

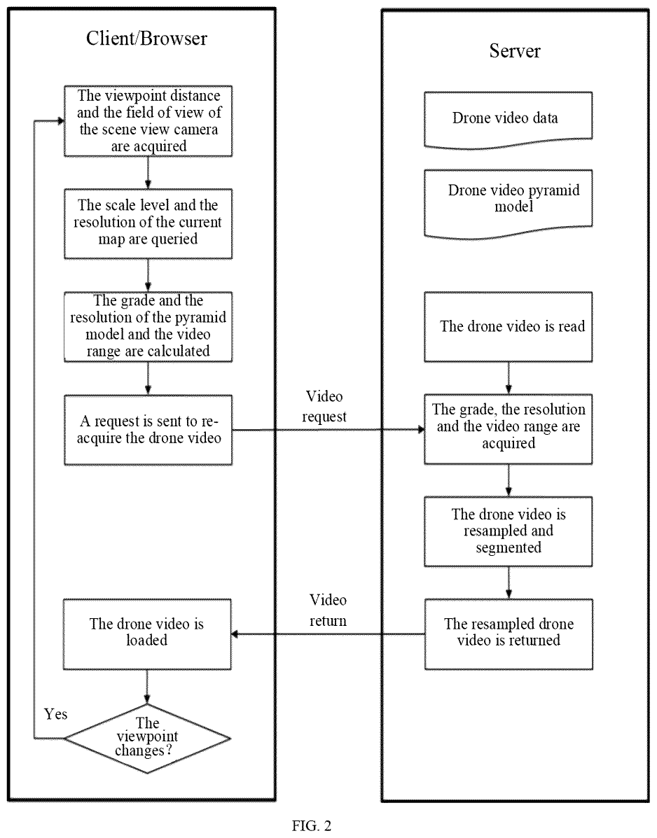

FIG. 2 is a schematic structural diagram of a dynamic processing method based on a drone video pyramid model according to an embodiment of the present disclosure.

The multi-resolution drone video dynamic processing method provided in the present disclosure is further described in detail below with reference to FIG. 2.

As shown in FIG. 2, the client/browser runs a drone image transmission system to load and display a drone video, and the server stores drone video data, and rules and methods for constructing the drone video pyramid model. The client and/or browser is configured to acquire the viewpoint distance and the field of view of the scene view camera, query the scale level of the current map, and acquire the resolution of the current map based on a current commonly-used correspondence between the scale level and the resolution of the map; the grade and the resolution of the drone video pyramid model are calculated based on the preset grading rule, the drone flight parameters and the resolution of the current map; the video range within the field of view of the scene view camera is calculated based on the drone video range and the field of view of the scene view camera; a request is sent to the video server to re-acquire the drone video of a corresponding resolution; the server resamples and segments the drone video based on parameters such as the grade, the resolution and the video range in the drone video request, and returns the resampled drone video; the resampled drone video is acquired in the three-dimensional scene, and the drone video is loaded and displayed; and in a case that the viewpoint of the three-dimensional scene changes, the above steps are repeated to schedule and render the multi-resolution drone video according to requirements.

It should be understood that the structural diagram shown in FIG. 2 is merely schematic, and the drone video pyramid model may be constructed by a user on the client according to his or her own needs.

According to the embodiments of the present disclosure, the preset grading rule mentioned above is determined based on formulas (1) to (3):

Hᵢ=360×Pᵢ (1),

$${W}_{i} = \frac{W}{H} \times 360 \times {P}_{i} , \qquad ( 2 )$$

$$R = \frac{tan ( α / 2 ) \times Height}{{H}_{i}} = \frac{tan ( α / 2 ) \times Height}{360 \times {P}_{i}} . \qquad ( 3 )$$

In the above formulas, W is an original width pixel value of the drone video, H is an original height pixel value of the drone video, Pᵢ (i=1, 2, 3 . . . ) is a grade of the drone video pyramid model, Hᵢ is a video height pixel value corresponding to the grade Pᵢ of the drone video pyramid model, Wᵢ is a video width pixel value corresponding to the grade Pᵢ of the drone video pyramid model, R is an actual resolution of the drone video, α is a vertical field of view of the drone, and Height is a current flight altitude of the drone.

The drone video pyramid model is constructed based on formulas (1) to (3). It may be known from the above formulas that the drone video pyramid model provided in the present disclosure includes a plurality of grades and a plurality of resolutions, and is capable of covering various video resolutions commonly used in the video field. Optionally, the user may determine a drone video pyramid model with other video resolutions based on the above formulas provided in the present disclosure according to his or her own needs.

According to the embodiments of the present disclosure, the drone video pyramid model includes a plurality of grades, each of which corresponds to a respective resolution.

The attribute information of the drone video pyramid model includes a grade of the drone video pyramid model and a resolution corresponding to the grade.

The resolutions of the drone video pyramid model sequentially increase from top to bottom.

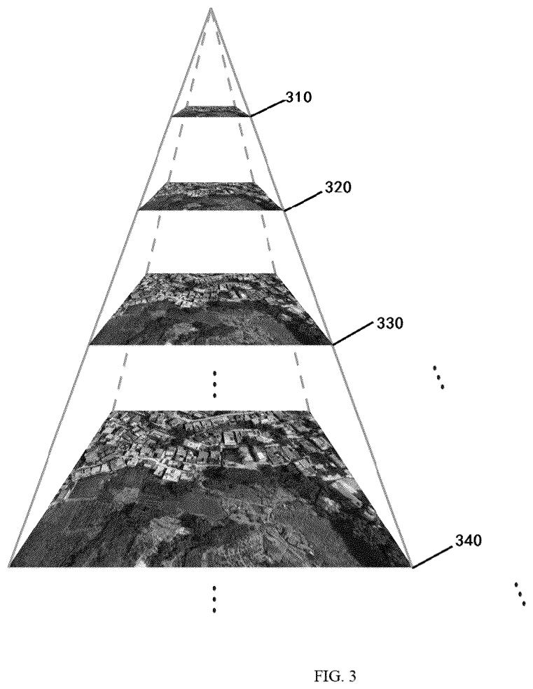

FIG. 3 is a schematic diagram of a general video format of a drone video pyramid model according to an embodiment of the present disclosure.

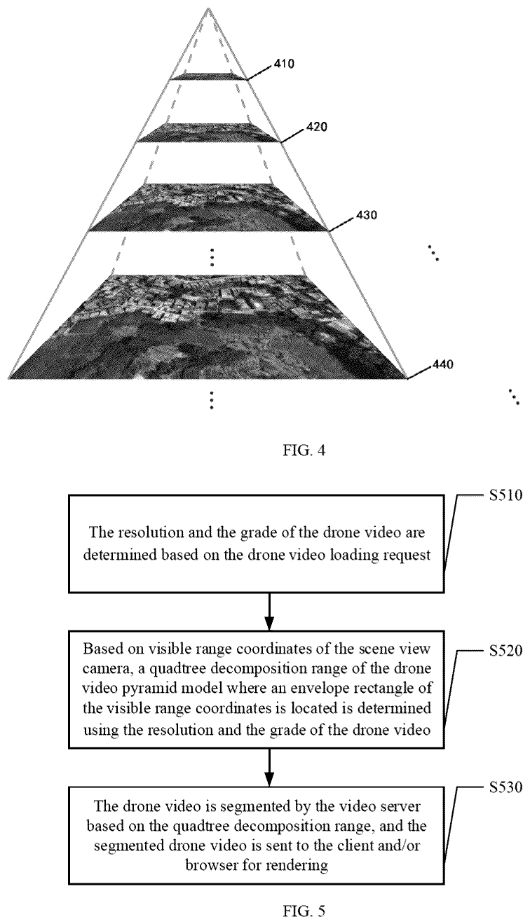

FIG. 4 is a schematic diagram of a 16:9 drone video format of a drone video pyramid model according to an embodiment of the present disclosure.

The drone video pyramid model provided in the present disclosure is further described in detail below with reference to FIG. 3 and FIG. 4.

FIG. 3 schematically shows the drone video pyramid model and the resolutions respectively corresponding to the grades of the pyramid model, where the resolution of an image 310 at a first grade of the drone video pyramid model is 360P, i.e. 360*W/H; the resolution of an image 320 at a second grade of the drone video pyramid model is 720P, i.e. 720*W/H; the resolution of an image 330 at a third grade of the drone video pyramid model is 1080P, i.e. 1080*W/H; and the resolution of an image 340 at a sixth grade of the drone video pyramid model is 4K, i.e. 2160*W/H. Here, W/H represents a ratio of a width of the drone video to a height of the drone video. For example, the ratio of the width to the height may be 1:1 or 16:9. Those skilled in the art will understand that FIG. 3 is only schematic, and they may construct a drone video pyramid model with N (N being a positive integer) grades (e.g., P1, P2, P3, P4, P5, P6 . . . PN) according to actual needs. Considering that the minimum unit of a map tile in a three-dimensional GIS system is usually of 256×256 pixels or 512×512 pixels, the present disclosure constructs a multi-resolution drone video pyramid grade by grade with the 360P video resolution as a basis resolution, so that common video resolutions such as 720P, 1080P, 4K and 8K may be all covered. The correspondence between the grade of the multi-resolution drone video pyramid and the pixel height and pixel width of the drone video is shown by formulas (1) and (2):

Hᵢ=360×Pᵢ (1),

$${W}_{i} = \frac{W}{H} \times 360 \times {P}_{i} . \qquad ( 2 )$$

FIG. 4 is a drone video pyramid model of a 16:9 (W/H, i.e. video width/video height) drone video format and the resolutions respectively corresponding to the grades of the pyramid model, where the resolution of an image 410 at the first grade of the drone video pyramid model is 360P, i.e., 640×360; and the resolution of an image 420 at the second grade of the drone video pyramid model is 720P, i.e., 1280×720; the resolution of an image 430 at the third grade of the drone video pyramid model is 1080P, i.e., 1920×1080; and the resolution of an image 440 at the sixth grade of the drone video pyramid model is 4K, i.e., 3840×2160. FIG. 4 is merely schematic, and the user may construct a pyramid model of 16:9 video format with a plurality of grades (e.g., P1, P2, P3, P4, P5, P6 . . . . PN) as desired. As shown in FIG. 4, for the 16:9 drone video format, the drone video width is determined based on formula (4):

Wᵢ=640×Pᵢ (4).

FIG. 3 and FIG. 4 schematically show structural diagrams of a drone video pyramid model according to an embodiment of the present disclosure. It may be evident from FIG. 3 and FIG. 4 that the drone video dynamic processing method provided in the present disclosure may process drone videos of different resolutions and may have a wide range of application scenarios. It is particularly noted that although FIG. 3 and FIG. 4 are schematic diagrams of a three-dimensional GIS scene, the drone video dynamic processing method provided in the present disclosure is also applicable to a two-dimensional GIS scene. In addition, combined with the pyramid model construction process mentioned above, the user may construct a drone video pyramid model with a plurality of other resolutions.

FIG. 5 is a flowchart of resampling and segmenting a drone video according to an embodiment of the present disclosure.

As shown in FIG. 5, the video server resamples and segments the drone video in response to the drone video loading request, which includes operations S510 to S530.

In operation S510, the resolution and the grade of the drone video are determined based on the drone video loading request.

In operation S520, based on visible range coordinates of the scene view camera and using the resolution and the grade of the drone video, a quadtree decomposition range of the drone video pyramid model where an envelope rectangle of the visible range coordinates is located is determined.

In operation S530, the drone video is segmented by the video server based on the quadtree decomposition range, and the segmented drone video is sent to the client and/or browser for rendering.

Those skilled in the art will understand that the user is usually only interested in part of the drone video, therefore, it is not necessary to load and display all the drone video within the field of view covered by the drone. Through such segmentation, the client may dynamically load or display the drone video according to the user needs. Furthermore, since the drone video is segmented according to the user needs, the pressure raised due to the dynamic scheduling and rendering by the client may be greatly reduced, so that the drone video may be loaded and displayed fast, thereby improving the user experience.

According to the embodiments of the present disclosure, the drone video is dynamically scheduled and rendered according to the preset requirement, which includes the following step.

In a case that the field of view of the scene view camera is smaller than a current image range of the drone video, part of the drone video data is loaded based on position information of the scene view camera, where the drone video has a plurality of resolutions.

According to the embodiments of the present disclosure, the above-mentioned drone video pyramid model includes a plurality of resolutions, including 360P, 720P, 1080P, 4K and 8K.

According to the embodiments of the present disclosure, the minimum unit of a map tile of the current map is of 256×256 pixels or 512×512 pixels.

The drone video pyramid model provided in the present disclosure samples and segments the drone video grade by grade based on a certain grading rule, which may take into account the size of a GIS map tile while covering the commonly used video resolutions such as 720P, 1080P, 4K and 8K, so that it is possible to load the multi-resolution drone video as desired.

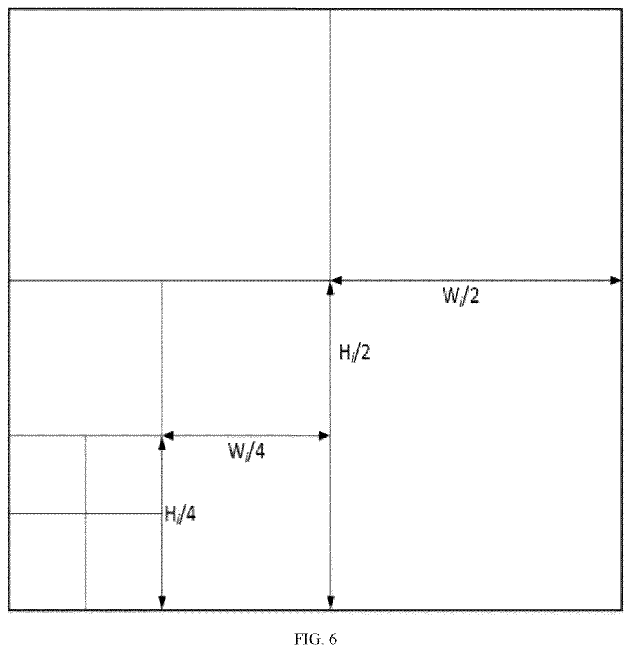

FIG. 6 is a schematic diagram of quadtree decomposition by a drone video pyramid model at a same grade according to an embodiment of the present disclosure.

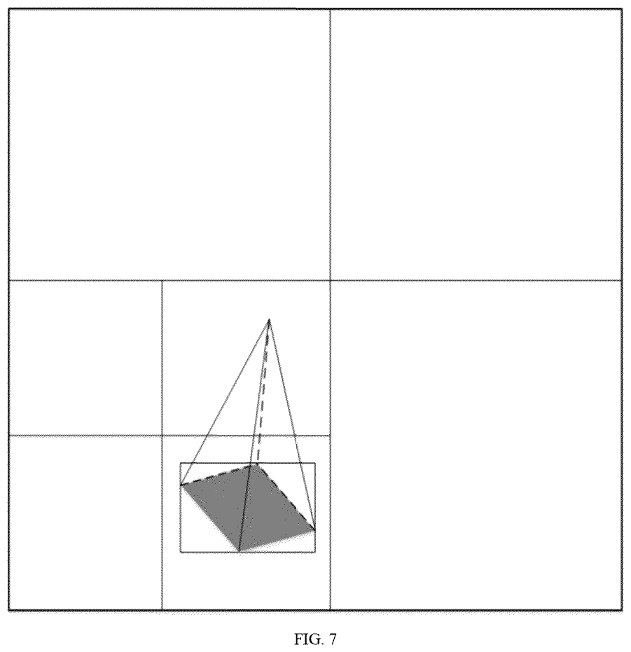

FIG. 7 is a schematic diagram showing calculation of a video range based on a visible range of a scene view camera according to an embodiment of the present disclosure.

The multi-resolution drone video dynamic processing method provided in the present disclosure is further described in detail below with reference to FIG. 6 and FIG. 7.

For the drone video of the same grade in the drone video pyramid model, quadtree decomposition may be performed, as shown in FIG. 6 and FIG. 7, so as to facilitate the loading of video data in a small range as desired. That is, in the case that the field of view of the scene view camera is smaller than the current image range of the drone, part of the video data may be loaded based on the position of the scene view camera, thereby reducing the video data amount and improving the scene rendering efficiency. FIG. 6 and FIG. 7 schematically show schematic diagrams of displaying part of a drone video or segmenting a drone video according to user needs according to the present disclosure, and those skilled in the art may replace the background of FIG. 6 and FIG. 7 with a drone video and/or a current map according to user needs, so as to facilitate the dynamic processing of the drone video. In FIG. 6, Wᵢ represents a width of the drone video corresponding to an i^{th} grade of the drone video pyramid model, Wᵢ/4 and Wᵢ/2 respectively represent ¼ and ½ of the width of the drone video; Hᵢ represents a height of the drone video corresponding to the i^{th} grade of the drone video pyramid model, and Hᵢ/4 and Hᵢ/2 respectively represent ¼ and ½ of the height of the drone video. FIG. 7 shows a schematic diagram of quadtree decomposition of a drone video according to an embodiment of the present disclosure. As shown in FIG. 7, the gray part is a result of the quadtree decomposition of the target drone video according to user needs, and the client may dynamically schedule and render, load and display the video image after quadtree decomposition.

The two-dimensional or three-dimensional GIS scene may dynamically load different levels of terrain, imagery and map data based on the current viewpoint distance. Therefore, during the dynamic scheduling of the drone video, drone video data of the same resolution may be dynamically requested based on the scale level of the current map. In the case that the drone video hardware remains unchanged, the drone field of view and the video size remain unchanged, and thus the actual resolution of the drone image is related to the drone flight altitude, as shown by formula (3):

$$R = \frac{tan ( α / 2 ) \times Height}{{H}_{i}} = \frac{tan ( α / 2 ) \times Height}{360 \times {P}_{i}} . \qquad ( 3 )$$

After the actual resolution and the grade of the current drone video is determined, based on visible range coordinates of the scene view camera (the scene view), a quadtree decomposition range of the video pyramid where an envelope rectangle of the visible range coordinates is located is calculated, and the server segments this part of video data based on the above-mentioned range and then sends it to the client for rendering.

During the loading and display process of the drone video in the two-dimensional or three-dimensional scene of the drone image transmission system, the required drone video resolution and the video range corresponding to the current grade are dynamically calculated based on the current viewpoint distance and the field of view. A low-resolution video is called in a case of a long distance, a high-resolution video is called in a case of a short distance, and a small-range video image is called in a case of a small field of view, so that the pressure of rendering the two-dimensional or three-dimensional scene may be reduced and the scene rendering performance may be improved.

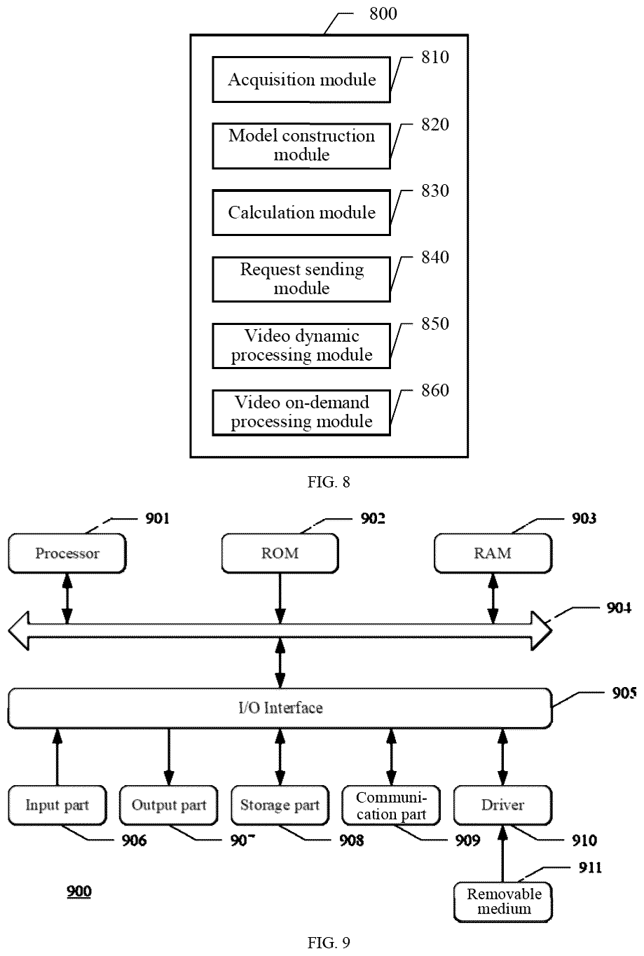

FIG. 8 is a schematic structural diagram of a multi-resolution drone video dynamic processing device according to an embodiment of the present disclosure.

As shown in FIG. 8, the multi-resolution drone video dynamic processing system includes an acquisition module 810, a model construction module 820, a calculation module 830, a request sending module 840, a video dynamic processing module 850 and a video on-demand processing module 860.

The acquisition module 810 is used to: acquire a viewpoint distance and a field of view of the scene view camera, query a scale level of the current map through the client, and acquire a resolution of the current map based on the viewpoint distance of the scene view camera and a correspondence between the scale level and the resolution of the map.

The model construction module 820 is used to construct a drone video pyramid model based on the resolution of the current map, drone flight parameters and a preset grading rule, where the drone video pyramid model includes a plurality of grades, each of which corresponds to a respective resolution.

The calculation module 830 is used to calculate a video range within the field of view of the scene view camera based on the field of view of the scene view camera and a video range of the drone.

The request sending module 840 is used to send a drone video loading request to a video server through the client, where the drone video loading request includes attribute information of the drone video pyramid model and the video range within the field of view of the scene view camera.

The video dynamic processing module 850 is used to: receive, through the client, the drone video resampled and segmented by the video server in response to the drone video loading request, and dynamically schedule and render, load and display the resampled and segmented drone video on the client.

The video on-demand processing module 860 is used to repeat the above steps in a case that the viewpoint distance of the scene view camera changes, so as to resample, segment, dynamically schedule and render, load and display the drone video according to a preset requirement.

The present disclosure provides a dynamic processing method and device based on a drone video pyramid model, which samples and segments a drone video grade by grade based on a certain grading rule. The present disclosure also provides a high-performance on-demand rendering method and device for a multi-resolution drone video, which dynamically loads drone video data of different resolutions and different ranges based on the distance, so that it may be ensured that drone videos, especially ultra-high-definition drone videos, are dynamically loaded and displayed as desired.

FIG. 9 schematically shows a block diagram of an electronic device applicable to implementing a dynamic processing method based on a drone video pyramid model according to an embodiment of the present disclosure.

As shown in FIG. 9, an electronic device 900 according to the embodiments of the present disclosure includes a processor 901, which may perform various appropriate operations and processes based on a program stored in a read-only memory (ROM) 902 or a program loaded from a storage portion 908 to a random-access memory (RAM) 903. The processor 901 may include, for example, a general-purpose microprocessor (e.g., a CPU), an instruction set processor and/or a related chip set and/or a special-purpose microprocessor (e.g., an application-specific integrated circuit (ASIC)), etc. The processor 901 may further include an on-board memory for caching. The processor 901 may include a single processing unit or a plurality of processing units for performing different operations of the method flow according to the embodiments of the present disclosure.

In the RAM 903, various programs and data necessary for operations of the electronic device 900 are stored. The processor 901, the ROM 902 and the RAM 903 are connected to each other via a bus 904. The processor 901 performs various operations of the method flow according to the embodiments of the present disclosure by executing the program in the ROM 902 and/or the RAM 903. It will be noted that the program may also be stored in one or more memories other than the ROM 902 and the RAM 903. The processor 901 may also perform the various operations of the method flow according to the embodiments of the present disclosure by executing program(s) stored in the one or more memories.

According to the embodiments of the present disclosure, the electronic device 900 may further include an input/output (I/O) interface 905, which is also connected to the bus 904. The electronic device 900 may further include one or more of the following components connected to the I/O interface 905: an input part 906 including a keyboard, a mouse, etc.; an output part 907 including a cathode ray tube (CRT), a liquid crystal display (LCD), a speaker, etc.; a storage part 908 including a hard disk, etc.; and a communication part 909 including a network interface card such as a LAN card, a modem, etc. The communication part 909 performs communication processing via a network such as the Internet. A driver 910 is also connected to the I/O interface 905 as desired. A removable medium 911, such as a magnetic disk, an optical disk, a magneto-optical disk, a semiconductor memory or the like, is mounted on the driver 910 as desired, so that a computer program read therefrom is installed into the storage portion 908 as desired.

The present disclosure further provides a computer-readable storage medium, which may be included in the device/apparatus/system described in the above embodiments; or may exist independently without being assembled into the device/apparatus/system. The computer-readable storage medium carries one or more programs, which when executed, implement the method according to the embodiments of the present disclosure.

According to the embodiments of the present disclosure, the computer-readable storage medium may be a non-volatile computer-readable storage medium, for example, may include but is not limited to: a portable computer disk, a hard disk, a random access memory (RAM), a read-only memory (ROM), an erasable programmable read-only memory (EPROM or flash memory), a portable compact disk read-only memory (CD-ROM), an optical storage device, a magnetic storage device, or any suitable combination of the above. In the present disclosure, a computer readable storage medium may be any tangible medium that may contain or store a program for use by or in connection with an instruction execution system, apparatus, or device. For example, according to the embodiments of the present disclosure, the computer-readable storage medium may include the ROM 902 and/or the RAM 903 described above and/or one or more memories other than the ROM 902 and the RAM 903.

Those skilled in the art will appreciate that the features described in the various embodiments and/or claims of the present disclosure may be combined and/or integrated in various ways, even if such combinations or integrations are not explicitly described in the present disclosure. In particular, various combinations and/or integrations of features recited in the various embodiments and/or claims of the present disclosure may be made without departing from the spirit and teachings of the present disclosure. All such combinations and/or integrations fall within the scope of the present disclosure.

The specific embodiments described above further introduce the purpose, technical solutions and beneficial effects of the present disclosure. It will be understood that the above descriptions are only specific embodiments of the present disclosure and are not intended to limit the present disclosure. Any changes, equivalent substitutions, improvements, etc. made within the spirit and principles of the present disclosure should fall within the scope of protection of the present disclosure.

1. A dynamic processing method based on a drone video pyramid model, comprising:
step 1, acquiring a viewpoint distance of a scene view camera and a field of view of the scene view camera; querying, by a client, a scale level of a current map; and acquiring a resolution of the current map based on the viewpoint distance of the scene view camera and a correspondence between the scale level of the map and the resolution of the map;
step 2, constructing a drone video pyramid model based on the resolution of the current map, drone flight parameters and a preset grading rule, wherein the drone video pyramid model comprises a plurality of grades, each of which corresponds to a respective resolution;
step 3, calculating a video range within the field of view of the scene view camera based on the field of view of the scene view camera and a drone video range;
step 4, sending, by the client, a drone video loading request to a video server, wherein the drone video loading request comprises attribute information of the drone video pyramid model and the video range within the field of view of the scene view camera;
step 5, receiving, by the client, a drone video resampled and segmented by the video server in response to the drone video loading request; and dynamically scheduling and rendering, loading and displaying the resampled and segmented drone video by the client; and
step 6, in a case that the viewpoint distance of the scene view camera changes, repeating the above step 1 to step 5 to resample, segment, dynamically schedule and render, load and display the drone video according to a preset requirement.

2. The method according to claim 1, wherein the preset grading rule is determined based on formulas (1) to (3):
Hᵢ=360×Pᵢ (1),
$${W}_{i} = \frac{W}{H} \times 360 \times {P}_{i} , \qquad ( 2 )$$
$$R = \frac{tan ( α / 2 ) \times Height}{{H}_{i}} = \frac{tan ( α / 2 ) \times Height}{360 \times {P}_{i}} , \qquad ( 3 )$$
wherein W is an original width pixel value of the drone video, His an original height pixel value of the drone video, Pᵢ (i=1, 2, 3 . . . ) is a grade of the drone video pyramid model, Hᵢ is a video height pixel value corresponding to the grade Pᵢ of the drone video pyramid model, Wᵢ is a video width pixel value corresponding to the grade Pᵢ of the drone video pyramid model, R is an actual resolution of a drone image, α is a vertical field of view of the drone, and Height is a current flight altitude of the drone.

3. The method according to claim 1, wherein the attribute information of the drone video pyramid model comprises a grade of the drone video pyramid model and a resolution corresponding to the grade,
wherein resolutions of the drone video pyramid model sequentially increase from top to bottom.

4. The method according to claim 1, wherein the video server resampling and segmenting the drone video in response to the drone video loading request comprises:
determining a resolution and a grade of the drone video based on the drone video loading request;
determining a quadtree decomposition range of the drone video pyramid model, where an envelope rectangle of visible range coordinates of the scene view camera is located, based on the visible range coordinates using the resolution and the grade of the drone video; and
segmenting, by the video server, the drone video based on the quadtree decomposition range, and sending the segmented drone video to the client and/or a browser for rendering.

5. The method according to claim 1, wherein dynamically scheduling and rendering the drone video according to the preset requirement comprises:
in a case that the field of view of the scene view camera is smaller than a current image range of the drone video, loading part of drone video data based on position information of the scene view camera.

6. The method according to claim 1, wherein the drone video pyramid model comprises a plurality of resolutions, and the plurality of resolutions comprise 360P, 720P, 1080P, 4K and 8K.

7. The method according to claim 1, wherein a minimum unit of a map tile of the current map is of 256×256 pixels or 512×512 pixels.

8. (canceled)

9. An electronic device, comprising:
one or more processors; and
a storage device configured to store one or more programs,
wherein when the one or more programs are executed by the one or more processors, the one or more processors perform the method according to claim 1.

10. A non-transitory computer-readable storage medium having executable instructions stored thereon, which, when executed by a processor, cause the processor to perform the method according to claim 1.
